(19) United States
(12) Patent Application Publication
(10) Pub. No.: US 2004/0238344 A1
(43) Pub. Date: Dec. 2, 2004

(54) Air purification system using excimer lamps for ultra-violet photocatalytic oxidation

(76) Inventors: Jeffrey T. Benoit, Willington, CT (US); Stephen O. Hay, South Windsor, CT (US); Timothy N. Obee, South Windsor, CT (US); Darren S. Sheehan, West Hartford, CT (US)

Correspondence Address: BACHMAN & LAPOINTE, P.C., 900 CHAPEL STREET, SUITE 1201, NEW HAVEN, CT, 06510, US

(21) Appl. No.: 10/448,863

(22) Filed: May 30, 2003

(51) Int. Cl. B01D 53/00

(52) U.S. Cl. 204/157.3; 422/186.3

(57) ABSTRACT

An air purification including a reaction zone for receiving a volume of air; and an excimer source of ultra-violet radiation adapted to expose the one to the ultra-violet radiation whereby photocatalytic oxidation of compounds in the air is accomplished.

### BACKGROUND OF THE INVENTION

The present invention relates to an air purification system and, more particularly, to an air purification system utilizing ultra-violet photocatalytic oxidation.

Typical designs for ultra-violet photocatalytic oxidation air purifiers use low-pressure mercury lamps to produce the UV radiation needed to catalyze the desired reactions.

Mercury lamps have several drawbacks. Most mercury lamps have ultra-violet outputs which are significantly reduced by cooling to temperatures around 10° C. However, an area of demand for air purifying systems is in heating, ventilation and air conditioning (HVAC) systems, where such temperatures are easily encountered. This reduction in UV output seriously reduces the ability of the system to deliver clean air at room temperatures.

In addition, mercury lamps are limited in power output before having undesirable efficiency and spectral saturation affects.

Further, mercury lamps, and the mercury used in such lamps, pose a significant environmental hazard, and are accompanied by specialized handling and disposal requirements when the lamp reaches the end of its useful life.

Based upon the foregoing, it is clear that the need remains for an improved system for purification of air through photocatalytic oxidation.

It is the primary object of the present invention to provide such a system and method.

It is a further object of the present invention to provide a system and method for carrying out photocatalytic oxidation at a greater efficiency.

Other objects and advantages of the present invention will appear hereinbelow.

### SUMMARY OF THE INVENTION

In accordance with the present invention, the foregoing objects and advantages have been readily attained.

According to the invention, an air purification system is provided which comprises a reaction zone for receiving a volume of air; and an excimer source of ultra-violet radiation adapted to expose said zone to said ultra-violet radiation whereby photocatalytic oxidation of compounds in said air is accomplished.

In further accordance with the invention, a heating, ventilation and air conditioning (HVAC) system is provided, which comprises an air delivery system adapted to generate an air flow having entrained volatile organic compounds; a reaction zone adapted to receive said air flow; and an excimer source of ultra-violet radiation adapted to expose said one to said ultra-violet radiation whereby photocatalytic oxidation of compounds in said air is accomplished.

In still further accordance with the invention, a method is provided for purifying air, which method comprises the steps of providing an airflow having entrained volatile organic compounds; and exposing said airflow to an excimer source of ultra-violet radiation in a photocatalytic oxidation zone whereby said organic compounds are decomposed. The photocatalytic oxidation zone includes an appropriate catalytic material.

### BRIEF DESCRIPTION OF THE DRAWINGS

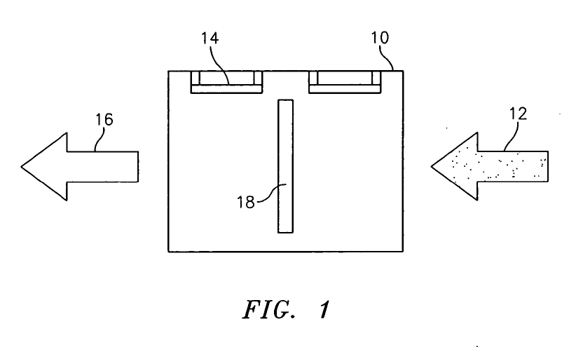

A detailed description of preferred embodiments of the present invention follows, with reference to the attached drawing, wherein FIG. 1 schematically illustrates a system and method in accordance with the present invention.

### DETAILED DESCRIPTION

The invention relates to an air purification system which can advantageously be utilized, preferably in a heating, ventilation and air conditioning (HVAC) environment, as well as a method for purification of an air stream, which advantageously utilizes excimer lamps to generate the required ultra-violet radiation and, thereby, to accomplish the desired photocatalytic oxidation of undesirable material such as volatile organic compounds that can become entrained in an airflow, for example from such an HVAC system.

The present invention is applicable to other gaseous and/or liquid fluid, especially gas, and the following description is provided in terms of air purification.

Air purification systems have wide applications, and one particularly preferred application in accordance with the present invention is incorporation into an HVAC system for use in purifying air circulated through the system.

Such an air purifier can advantageously be used to purify contaminated air, for example as in an office building.

Such air stream or flows can readily contain entrained volatile organic compounds, and it is desirable to remove such compounds from the stream. As is known to a person of ordinary skill in the art, such compounds can be decomposed utilizing photocatalytic reactions, which are catalyzed by ultra-violet radiation.

In accordance with the present invention, a system is provided, a portion of which is schematically illustrated in FIG. 1, which includes a reaction zone 10 adapted to receive a stream of gas, in this embodiment air 12, and to expose air 12 to an excimer source 14 of ultra-violet radiation in the presence of an appropriate catalyst, whereby photocatalytic oxidation of compounds contained in the air is accomplished so as to generate a purified stream of air 16 as desired.

The system as illustrated in FIG. 1 can be incorporated as a portion of an air circulation system, for example in a HVAC system, or in other environments wherein air, or a stream of air, having contaminants which can be subjected to photocatalytic oxidation is encountered.

In accordance with the present invention, excimer source 14 is advantageously provided in the form of excimer lamps, preferably excimer lamps containing excimer complexes which have emission wavelengths in the UV region of interest for photocatalyses, preferably less than about 400 nm. Examples of suitable excimer complexes are set forth in Table 1 below:

TABLE 1

| Excimer | Λ (nm) | ηₘₐₓ |
|---|---|---|
| NeF^{*} | 108 | 0.43 |
| Ar₂ | 129 | 0.50 |
| Kr₂ | 147 | 0.47 |
| F₂ | 158 | 0.44 |
| Xe₂ | 172 | 0.48 |
| ArCl^{*} | 175 | 0.48 |
| KrI^{*} | 185 | 0.37 |
| ArF^{*} | 193 | 0.35 |
| KrBr^{*} | 206 | 0.33 |
| KrF^{*} | 249 | 0.28 |
| KrCl^{*} | 222 | 0.31 |
| XeI^{*} | 253 | 0.37 |
| Cl₂ | 258 | 0.32 |
| XeBr^{*} | 282 | 0.29 |
| Br₂ | 290 | 0.29 |
| XeCl^{*} | 308 | 0.27 |
| I₂ | 343 | 0.24 |
| XeF^{*} | 346 | 0.24 |

Of these complexes, those having a wavelength of less than about 180 nm can be used with a suitable phosphor on the lamp. Thus, the preferred excimer lamps emit ultra-violet radiation at a wavelength of between about 180 and about 400 nm, more preferably between about 200 and about 360 nm. Specific examples of preferred excimer complexes include XeI* (253 nm), XeCl* (308 nm) and combinations thereof.

Additional excimer complexes with lower emission wavelengths, such as Xe₂ (172 nm), can be made suitable for UVPCO applications, for example through use of an appropriate phosphor on the lamp for shifting the wavelength to the desired range as cited above.

It should be appreciated that while these are examples of suitable excimer complexes, other excimer complexes could likewise be used.

Such lamps can be powered by various methods or sources, including standard direct current, alternating current or pulsed discharges as well as electrodeless microwave or dielectric barrier discharges, and the like.

Excimer are excited molecules that do not have a stable ground state. Such excimers only exist in their excited energy state, and they typically have a very short lifetime. This results in quick release of energy as they fall back to a ground state and dissociate. The short lifetime means that the relative density of excimers within an excimer plasma is very low and, thus, the body of the plasma re-absorbs only a small fraction of the radiation emitted thereby. This is in contrast to conventional mercury plasmas that more easily re-absorb their emitted radiation. This difference in re-absorption allows the excimer lamp to emit a much greater UV energy per volume of plasma than can be accomplished using low pressure mercury lamps. Further, most excimer lamps tend to have very little temperature dependence as compared to mercury lamps.

In further accordance with the invention, a suitable catalyst is positioned within the reaction zone for contact with the air stream of air during exposure to ultraviolet light. This catalyst can be positioned within reaction zone 10 in the form of a structure 18 which can advantageously be coated with the appropriate catalyst. This structure 18 can, for example, be a photocatalytic monolith provided through catalytic coating of a honeycomb structure. The honeycomb structure is suitably selected to provide minimal resistance to fluid flow through, whereby the desired UVPCO reaction can be conducted with minimal pressure increase.

In this regard, a commonly owned and simultaneously filed application dealing with Tungsten Oxide/Titanium Dioxide Photocatalyst, bearing Attorney Docket No. 60/246,204, is incorporated herein by reference.

In accordance with the invention, structure 18 is provided in the photocatalytic reaction zone, and illuminating catalyst coated structure 18 while subjecting structure 18 to airflow 12 decomposes entrained volatile organic compounds in the stream on structure 18 so as to generate purified stream 16 as desired.

It should readily be appreciated that the use of excimer lamps for generating the desired ultra-violet radiation is particularly advantageous in the HVAC environment, where temperatures such as 10° C. which can frequently be encountered, do not adversely affect the performance of such lamps in generating ultra-violet radiation.

It should further be appreciated that such lamps, when their useful lifetime has been exhausted, do not pose the same environment hazards in disposal as are posed by mercury lamps.

Finally, such lamps further enhance the efficiency of the system since excimer plasma has such a low re-absorption of emitted radiation.

Thus, a system and method are provided in accordance with the present invention whereby purified air can readily be obtained without serious disadvantages which are encountered in the prior art.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A fluid purification system, comprising:
a reaction zone for receiving a volume of fluid; and
an excimer source of ultra-violet radiation adapted to expose said zone to said ultra-violet radiation whereby photocatalytic oxidation of compounds in said fluid is accomplished.

2. The system of claim 1, wherein said system further comprises a catalyst structure in said zone.

3. The system of claim 1, wherein said excimer source is an excimer complex selected from the group consisting of NeF, Ar₂, Kr₂, F₂, Xe₂, ArCl*, KrI*, ArF*, KrBr*, KrF*, KrCl*, XeI*, Cl₂, XeBr*, Br₂, XECl*, I₂, XeF* and combinations thereof.

4. The system of claim 1, wherein said excimer source is an excimer lamp.

5. The system of claim 4, wherein said excimer lamp comprises at least one excimer complex selected from the group consisting of Xe₂*, XeI*, XeCl* and combinations thereof.

6. The system of claim 5, wherein said excimer complex is a phosphor coated Xe₂* lamp.

7. The system of claim 4, wherein said excimer lamp emits said ultra-violet radiation at a wavelength of between about 180 nm and about 400 nm.

8. The system of claim 4, wherein said excimer lamp emits said ultra-violet radiation at a wavelength of between about 200 nm and about 360 nm.

9. The system of claim 1, wherein said reaction zone is communicated with a source of air having entrained volatile organic compounds, and wherein said ultra-violet radiation decomposes said organic compounds.

10. A heating, ventilation and air conditioning system, comprising:
an air delivery system adapted to generate an air flow having entrained volatile organic compounds;
a reaction zone adapted to receive said air flow; and
an excimer source of ultra-violet radiation adapted to expose said zone to said ultra-violet radiation whereby photocatalytic oxidation of compounds in said air is accomplished.

11. The system of claim 10, wherein said system further comprises a catalyst structure in said zone.

12. The system of claim 10, wherein said excimer source is an excimer complex selected from the group consisting of NeF, Ar₂, Kr₂, F₂, Xe₂, ArCl*, KrI*, ArF*, KrBr*, KrF*, KrCl*, XeI*, Cl₂, XeBr*, Br₂, XECl*, I₂, XeF* and combinations thereof.

13. The system of claim 10, wherein said excimer source is an excimer lamp.

14. The system of claim 13, wherein said excimer lamp comprises at least one excimer complex selected from the group consisting of Xe₂*, XeI*, XeCl* and combinations thereof.

15. The system of claim 14, wherein said excimer complex is a phosphor coated Xe₂* lamp.

16. The system of claim 13, wherein said excimer lamp emits said ultra-violet radiation at a wavelength of between about 180 nm and about 400 nm.

17. The system of claim 13, wherein said excimer lamp emits said ultra-violet radiation at a wavelength of between about 200 nm and about 360 nm.

18. A method for purifying air comprising the steps of:
providing a stream of air having entrained volatile organic compounds; and
exposing said stream to an excimer source of ultra-violet radiation in a photocatalytic oxidation zone whereby said organic compounds are decomposed.

19. The method according to claim 18, wherein said system further comprises a catalyst structure in said zone.

20. The method according to claim 18, wherein said excimer source is an excimer complex selected from the group consisting of NeF, Ar₂, Kr₂, F₂, Xe₂, ArCl*, KrI*, ArF*, KrBr*, KrF*, KrCl*, XeI*, Cl₂, XeBr*, Br₂, XECl*, I₂, XeF* and combinations thereof.

21. The method according to claim 18, wherein said excimer source is an excimer lamp.

22. The method according to claim 21, wherein said excimer lamp comprises at least one excimer complex selected from the group consisting of Xe₂, XeI*, XeCl and combinations thereof.

23. The method according to claim 22, wherein said excimer complex is a phosphor coated Xe₂* lamp.

24. The method according to claim 21, wherein said excimer lamp emits said ultra-violet radiation at a wavelength of between about 180 nm and about 40 nm.

25. The method according to claim 21, wherein said excimer lamp emits said ultra-violet radiation at a wavelength of between about 200 nm and about 360 nm.
